(19) United States
(12) Patent Application Publication
(10) Pub. No.: US 2016/0216871 A1
(43) Pub. Date: Jul. 28, 2016

(54) VIDEO CAPTURE AND SHARING

(71) Applicant: TWITTER, INC., San Francisco, CA (US)

(72) Inventor: Paul STAMATIOU, San Francisco, CA (US)

(21) Appl. No.: 15/008,393

(22) Filed: Jan. 27, 2016

Related U.S. Application Data
(60) Provisional application No. 62/108,533, filed on Jan. 27, 2015.

(51) Int. Cl. G06F 3/0484; H04N 5/232; G11B 27/036; G06F 3/0488; G06F 3/0483

(52) U.S. Cl. CPC G06F 3/04845; G06F 3/04883; G06F 3/0483; G06F 3/04842; G11B 27/036; H04N 5/23293

(57) ABSTRACT

A method includes capturing a first segment of video content, and displaying the video content of the captured first segment in a first page of a graphical user interface (GUI) of an application executing on a mobile device as the first segment is being captured, where the GUI is displayed on a touchscreen. A second segment of video content is captured, where the second segment is not temporally contiguous with the first segment, and, as the second segment is being captured, a first static screenshot of a frame of the first segment of video content is displayed in the page of the GUI and the video content of the captured second segment is also displayed in the page of the GUI.

### CROSS REFERENCE TO RELATED APPLICATION

This application is a non-provisional of, and claims priority to, U.S. Patent Application No. 62/108,533, filed on Jan. 27, 2015, entitled “VIDEO CAPTURE AND SHARING” which is incorporated by reference herein in its entirety.

### BACKGROUND

This disclosure generally relates to the capture and sharing of video content.

The use of computing devices has greatly increased in recent years. Computing devices such as tablet computers, smart phones, cellular phones, and netbook computers, are now commonplace throughout society. Computing devices also exist with other devices, such as, for example, cars, planes, household appliances, and thermostats. With this increase in the number of computing devices, the information that is shared between computers also has greatly increased. For example, users often capture video content with their computing devices and share the captured video content. However, the processes of capturing and sharing video content are generally separate processes, which is cumbersome and inefficient for users.

### SUMMARY

Techniques, methods, and systems are disclosed herein for efficiently capturing and sharing video content with a mobile computing system. A messaging application executing on the mobile computing system can present a page of a graphical user interface (GUI) on a touchscreen of the device, and a user can interact with the GUI within the page to capture different segments of video content. Within the page, the user can initiate the capture of new segments of video content through interaction with the GUI, while previously captured segments continue to be displayed within the page of the GUI. The different segments can be displayed within the page of the GUI, and the user can edit the different segments and compose a single video content file from one or more of the different segments displayed within the page of the GUI. When the single video content file is composed from one or more different segments of captured video content, the single video content file can be appended to a message that is shared by the user with other users by the messaging application.

In a first aspect, a method includes capturing a first segment of video content, and displaying the video content of the captured first segment in a first page of a graphical user interface (GUI) of an application executing on a mobile device as the first segment is being captured, where the GUI is displayed on a touchscreen. A second segment of video content is captured, where the second segment is not temporally contiguous with the first segment, and, as the second segment is being captured, a first static screenshot of a frame of the first segment of video content is displayed in the page of the GUI and the video content of the captured second segment is also displayed in the page of the GUI.

Implementations can include one or more of the following features, alone or in any combination with each other. For example, after the second segment is captured, the first static screenshot and a second static screenshot of a frame of the second segment of video content can be displayed in the first page of the GUI. A single file of video content that includes the first and second segments can be generated.

The first and second static screenshots can be displayed in the first page of the GUI in a predetermined order, and a user's interaction with at least one of the static screenshots can be received on the touchscreen, and in response to the received user's interaction, the first and second static screenshots can be displayed within the first page in a user-determined order different from the predetermined order. Then, the single file of video content can include the content of the first and second segments arranged in the user-determined order. The predetermined order can be the order in which the segments were captured. The first and second segments of video content can be ordered for playback in the single file of video content in the user-determined order.

A user's selection of one of the first or second static screenshots can be received on the touchscreen, and, in response to receiving the user selection, the video content corresponding to the selected static screenshot in the page can be played back while displaying the non-selected static screenshot in the page.

After generating the single file of video content that includes the first and second segments, a first user input to the GUI in the first page can be received. In response to receiving the first user input to the GUI, a text entry GUI for receiving text input by the user for inclusion in a message to be sent to other users can be displayed in a second page of the GUI of the application. Also, in response to receiving the first user input to the GUI, the single file of video content can be attached to the message to be sent to other users. The first user input to the GUI can include includes a single touch of the touchscreen. The message that includes the single file of video content can be sent to be broadcasted to other users through a social media platform in which the user and the other user participate.

A user interface element that is selectable to initiate the capture of the segments of video content can be displayed in the second page of the GUI of the application.

Three or more segments of video content that are not temporally contiguous with each other can be captured. Static screenshots corresponding to the three or more segments of video content can be displayed within the first page in a predetermined order. A user's selection, on the touchscreen, with at least one of the static screenshots can be received, and, in response to the received user's selection, the selected static screenshot can be deleted from the display. A user's interaction, on the touchscreen, with at least one of the displayed static screenshots can be displayed, and, in response to the received user's interaction, the static screenshots that have not been deleted within the page can be displayed in a user-determined order different from the predetermined order. Then, the single file of video content can include the content of the segments of video content corresponding to the displayed static screenshots, after the selected static screenshot has been deleted, arranged in the user-determined order.

In another general aspect, a mobile computing system includes a camera configured for capturing segments of video content that are not temporally contiguous, a display including a touchscreen configured for displaying the captured segments of the video content and for displaying static screenshots of the captured segments of the video content and for receiving interactions by a user with the touchscreen, one or more memory devices configured for storing executable instructions, and one or more processors configured for executing the instructions. Execution of the instructions causes the system to execute an application on the mobile computing device for receiving and displaying a stream of messages that have been broadcast by other users. Execution of the application includes capturing a plurality of segments of video content that are not temporally contiguous in a page of a graphical user interface (GUI) of the application, displaying the video content of the captured segments in the page of the GUI on the touchscreen as the segments are being captured, while displaying static screenshots of frames other one or more captured segments in the page, generating a single file of video content that includes the video content of two or more of the segments, in response to receiving a user's interaction with one or more of the static screenshots through the touchscreen, receiving, through the GUI of the application, text input by the user for inclusion in a message to be broadcast to other users, and attaching the single file of video content to the message to be broadcast.

In another general aspect, a mobile computing system includes a camera configured for capturing segments of video content that are not temporally contiguous, a display including a touchscreen configured for displaying the captured segments of the video content and for displaying static screenshots of the captured segments of the video content and for receiving user interactions with the touchscreen, one or more memory devices configured for storing executable instructions, and one or more processors configured for executing the instructions. Execution of the instructions causes the system to capture a first segment of video content, display the video content of the captured first segment in a first page of a graphical user interface (GUI) of an application executing on the mobile computing system as the first segment is being captured, where the GUI is displayed on the touchscreen, capture a second segment of video content, where the second segment is not temporally contiguous with the first segment, and, as the second segment is being captured, display a first static screenshot of a frame of the first segment of video content in the page of the GUI and display the video content of the captured second segment in the page of the GUI.

Implementations can include one or more of the following features, alone or in any combination with each other. For example, the display, the one or more memory devices, and the one or more processors can be integrated into a first single housing, and the camera can located a second housing peripheral to the first housing, while the camera communicates with the one or more processors over a wireless link.

Execution of the instructions can further cause the system to, after the second segment is captured, display, in the first page of the GUI, the first static screenshot and a second static screenshot of a frame of the second segment of video content. Execution of the instructions can further cause the system to generate a single file of video content that includes the first and second segments. Execution of the instructions can further cause the system to display, in the first page of the GUI, the first and second static screenshots within the page in a predetermined order, and receive a user's interaction, on the touchscreen, with at least one of the static screenshots. In response to the received user's interaction, the first and second static screenshots can be displayed within the first page in a user-determined order different from the predetermined order, and the single file of video content can include the content of the first and second segments arranged in the user-determined order. The predetermined order can be the order in which the segments were captured.

Execution of the instructions can further cause the system to order the first and second segments of video content for playback in the single file of video content in the user-determined order.

Execution of the instructions can further cause the system to receive a user's selection, on the touchscreen, of one of the first or second static screenshots, and, in response to receiving the user selection, the video content corresponding to the selected static screenshot can be played back in the page while displaying the non-selected static screenshot in the page.

Execution of the instructions can further cause the system to receive a first user input to the GUI in the first page after generating the single file of video content that includes the first and second segments. In response to receiving the first user input to the GUI, a text entry GUI for receiving text input by the user for inclusion in a message to be sent to other users can be displayed, in a second page of the GUI of the application, and the single file of video content can be attached to the message to be sent to other users. The first user input to the GUI can include a single touch of the touchscreen.

Execution of the instructions can further cause the system to capture three or more segments of video content that are not temporally contiguous with each other, to display static screenshots corresponding to the three or more segments of video content within the first page in a predetermined order, to receive a user's selection, on the touchscreen, with at least one of the static screenshots, and, in response to the received user's selection, to delete the selected static screenshot from the display. A user's interaction, on the touchscreen, with at least one of the displayed static screenshots can be received, and, in response to the received user's interaction, the static screenshots that have not been deleted within the page in a user-determined can be displayed in an order different from the predetermined order. Then, the single file of video content can include the content of the segments of video content corresponding to the displayed static screenshots, after the selected static screenshot has been deleted, arranged in the user-determined order.

### BRIEF DESCRIPTION OF THE DRAWINGS

FIG. 1 is a schematic diagram of a mobile computing system for capturing and sharing video content.

FIG. 2A is a screenshot of a graphical user interface in which a user of a mobile computing system can initiate the composition of a message to one or more other users, where the message includes video content.

FIG. 2B is a screenshot of a graphical user interface similar in which a prompt is provided to the user to let the user know that it is possible to capture video content in the graphical user interface that is used to compose a message.

FIG. 3 is a screenshot of the graphical user interface that can be displayed in the touchscreen of the display and that can be used to capture video content.

FIG. 4 is a screenshot of a graphical user interface that can be displayed in the touchscreen of the display and that can be used to capture video content.

FIG. 5 is a screenshot of a graphical user interface that can be displayed in the touchscreen of the display and that can be used to capture video content and also to display a thumbnail of previously-captured video content.

FIG. 6 is a screenshot of a graphical user interface that can be displayed in the touchscreen of the display and that can be used to capture video content and also to display thumbnails of a plurality of previously captured video content segments.

FIG. 7 is a screenshot of a graphical user interface that can be displayed in the touchscreen of the display and that can be used to capture video content and also to display thumbnails of a plurality of previously captured video content segments.

FIG. 8 is a screenshot of a graphical user interface that can be displayed in the touchscreen of the display and that can be used to capture video content, to display thumbnails of a plurality of previously captured video content segments, and to edit previously-captured video segments into a single video file that can be attached to a message that is sent from a user to one or more other users.

FIG. 9 is a screenshot of a graphical user interface that can be displayed in the touchscreen of the display and that can be used to display thumbnails of a plurality of previously captured video content segments and to edit previously-captured video segments into a single video file that can be attached to a message that is sent from a user to one or more other users.

FIG. 10 is a screenshot of a graphical user interface that can be displayed in the touchscreen of the display.

FIG. 11 is a screenshot of the graphical user interface that can be displayed in the touchscreen of the display and can be used for editing and playing back video content.

FIG. 12 is a screenshot of a graphical user interface that can be used to generate a message to accompany the single video file composed from content of the plurality of different video content segments.

FIG. 13 shows seven different screenshots of different graphical user interfaces showing how the techniques described herein also can be implemented in landscape orientations of the graphical user interfaces.

FIG. 14A shows a messaging platform and a client computing device that can be used to compose and send a message containing a single video content file composed of a plurality of video content segments captured with the a mobile computing device.

FIG. 14B shows an example depiction of a connection graph in accordance with one or more implementations of the invention.

FIG. 15 illustrates a diagrammatic representation of a machine in the example form of a computing device within which a set of instructions, for causing the machine to perform any one or more of the methodologies discussed herein, may be executed.

### DETAILED DESCRIPTION

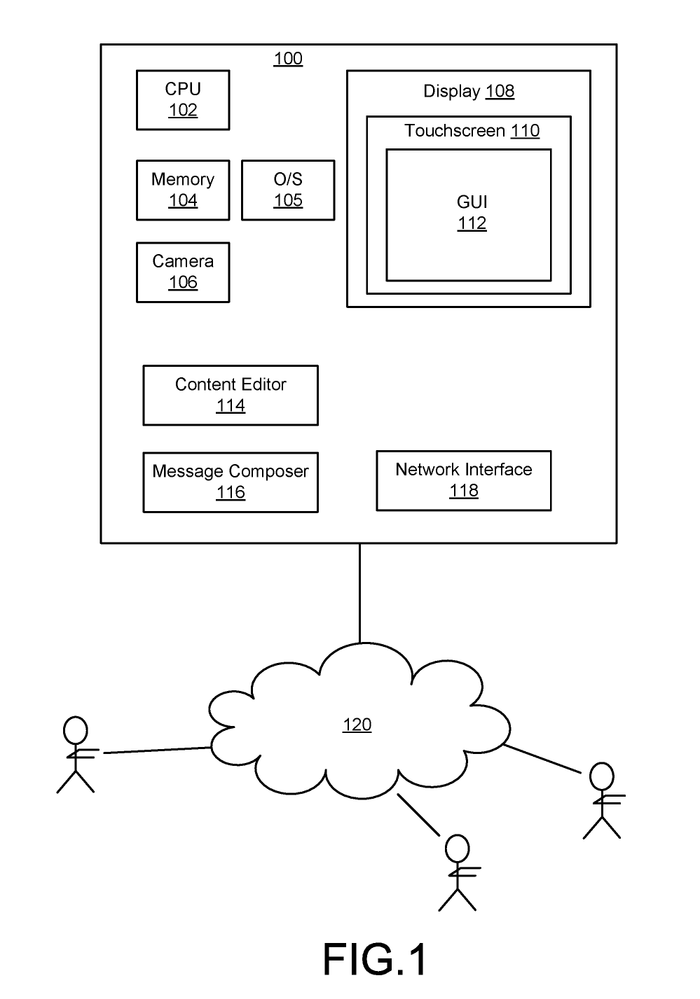

FIG. 1 is a schematic diagram of a mobile computing system 100 for capturing and sharing video content. The mobile computing system 100 can include a phone, a tablet, a notebook, a laptop, a camera, a media player, a wearable device, an automobile, etc. The mobile computing system 100 includes one or more processors 102 for executing instructions stored in one or more memories 104. Although a single processor and a single memory are shown in FIG. 1, it is understood that the processor 102 in FIG. 1 can represent one or more processors, and that the memory 104 can represent one or more memory devices. The mobile computing system 100 can include an operating system 105 and one or more executable applications.

The mobile computing system 100 can include a camera 106 for capturing video content and for capturing still images. A display 108, at least a portion of which can include a touchscreen 110, can display graphical user interface 112, with which a user of the system 100 can interact with the video content captured by the camera 106. A content editor module 114 can be used to manipulate and edit video content displayed in the GUI 112 and a message composer module 116 can be used to compose a message that includes video content and that is to be sent from the system 100. A network interface 118 can provide an interface between the system 100 and a network 120 (e.g., the Internet), so that a message can be sent from the system 100 through the network 122 another user.

In some implementations, elements of the mobile computing system 100 can be physically separated from each other, yet communicate with each other via wireless or wired links. For example, in one implementation, the camera 106 could be mounted on a helmet (or another wearable device, e.g., eyeglasses) worn by the user, while the GUI 112 is presented on a display 108 of a smart phone, tablet, or a wrist-mounted wearable device carried by the user. In such an implementation, the different physical elements of the system can communicate with each other via a short range wireless communications protocol (e.g., Bluetooth). In another example implementation, the camera 106 could be mounted on a movable vehicle, such as, for example, a model automobile or a flying drone, while the GUI 112 is presented on a display 108 of a smart phone, tablet, etc. that is in communication with the moving vehicle.

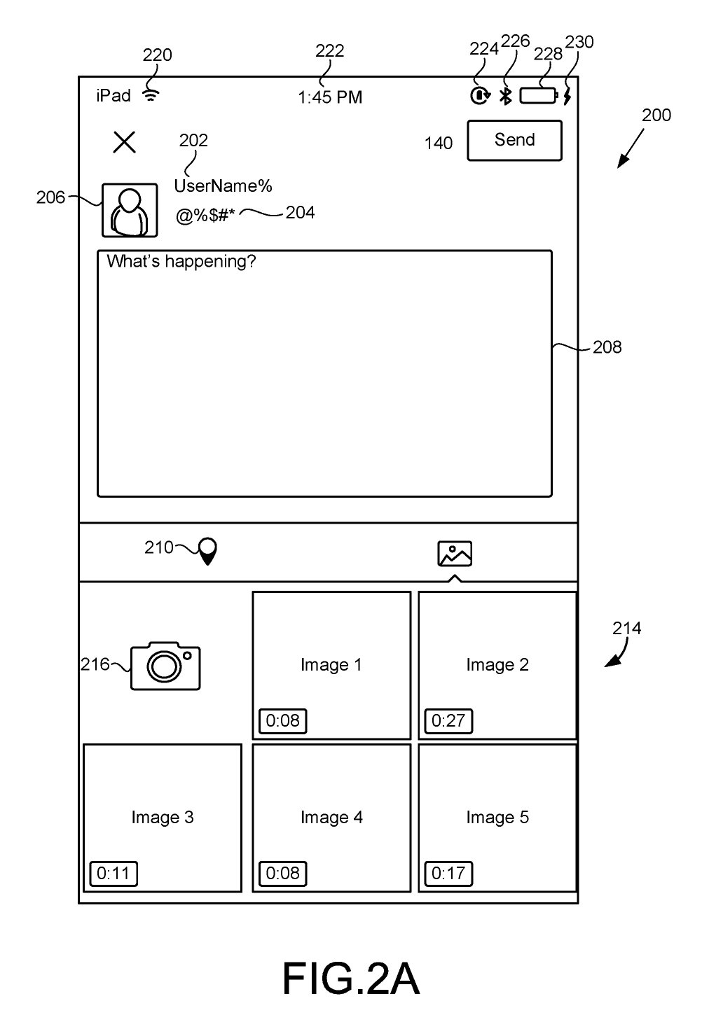

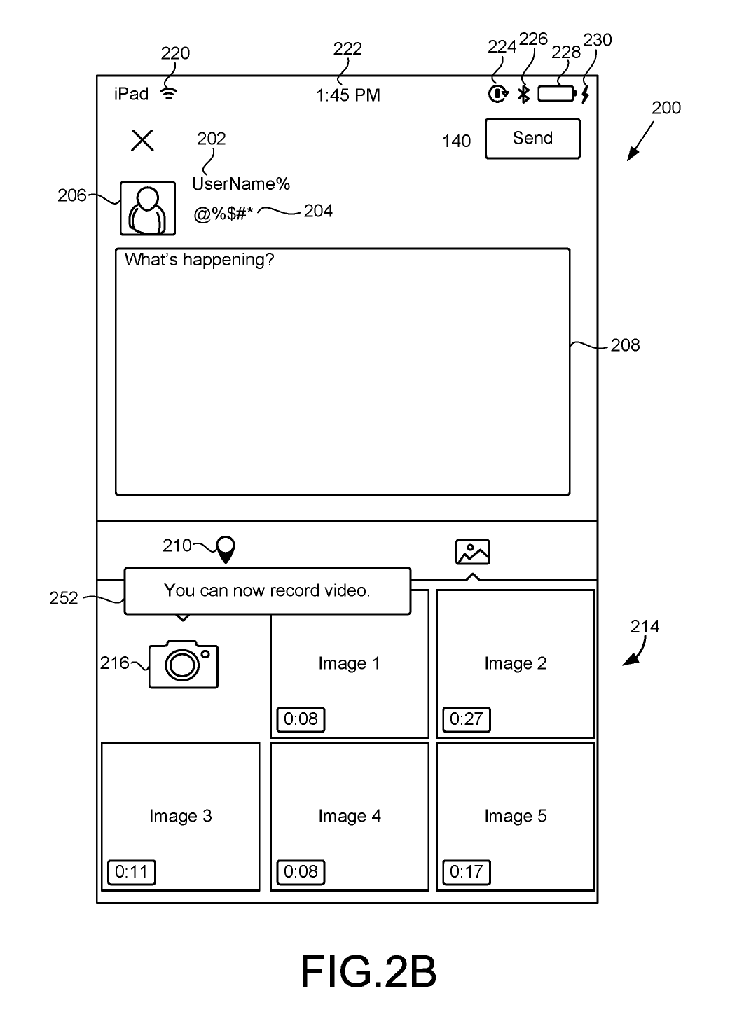

FIG. 2A is a screenshot of a graphical user interface (GUI) 200 in which a user of a mobile computing system can initiate the composition of a message to one or more other users, where the message includes video content. The message can be one that is broadcast to other users that are connected to the user by a connection graph for inclusion in a stream of messages displayed to the other users by a computer-executed application. For example, the GUI 200 can be displayed when a mobile client or a Web client of a social media application is executed on the system 100, where a user can enter text and video content through the GUI to be broadcast to other users, who also use the social media application, and who are connected to the user through the social media application. The GUI 200 can be provided as part of a page of content that is displayed to a user when an application is executed by the system 100. The GUI 200 can be provided on a touchscreen surface of the display 108 and can be controlled by an application stored in memory executed by a processor of the system. The GUI 200 can include a number of different user interface elements. For example, the GUI 200 can include a name 202, a handle 204, and an avatar 206 representing the user of the device who is composing the message. The GUI 200 can include a text space 208 in which the user can enter text for the message to be sent. Additionally, the GUI 200 can include a user interface element 210 with which the user can append a location from which the message is being sent to the message, a user interface element 212 that can be selected to call up a gallery 214 of video content that can be appended to the message, and a user interface element 216 that can be selected to initiate the capture of new video content from the mobile computing system. Along with the GUI 200, the display 108 also can provide one or more user interface elements 220, 222, 224, 226, 228, and 230, which may be controlled by the operating system 105 of the system 100, and that provide system-level information to the user.

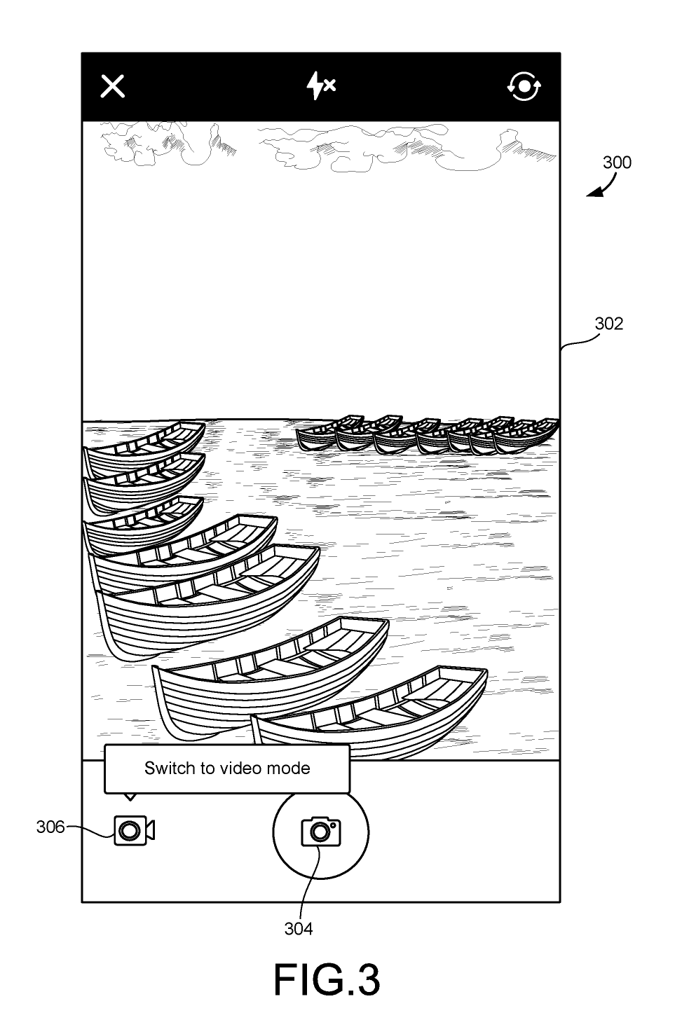

FIG. 2B is a screenshot of a graphical user interface 250 similar to that of the GUI 200 in which a prompt 252 is provided to the user to let the user know that it is possible to capture video content in the GUI that is used to compose a message. Selection of the icon 216 on the touchscreen 110 that displays the GUI 200 or 250 can cause the display of the GUI 300 displayed in FIG. 3.

FIG. 3 is a screenshot of the GUI 300 that can be displayed in the touchscreen 110 of the display 108 and that can be used to capture video content. The GUI 300 can include a viewfinder portion 302 that displays an image of a scene focused onto a light sensor of the camera 106 and a user interface element 304 that can be selected on the touchscreen that displays the GUI 300 to take a still image (e.g., a photograph) of the scene in the viewfinder. Additionally, the GUI 300 can include a user interface element 306 that can be selected on the touchscreen 110 and received by the message composer 116 to put the mobile computing system into a video capture mode so that a video of the scene displayed in the viewfinder 302 can be captured by the system.

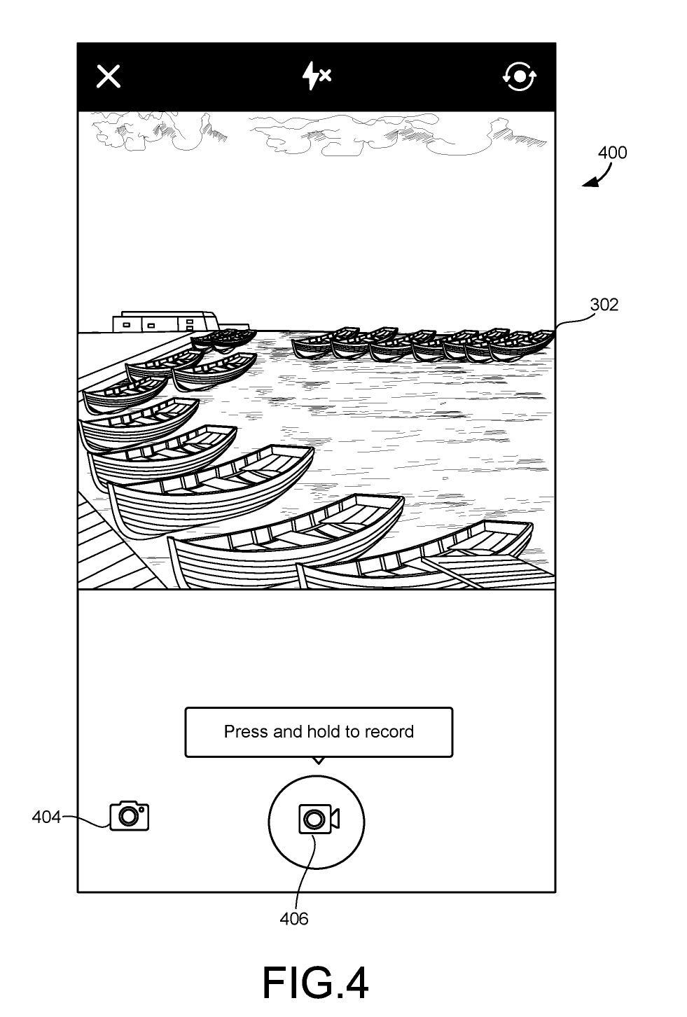

FIG. 4 is a screenshot of a GUI 400 that can be displayed in the touchscreen 110 of the display 108 and that can be used to capture video content. The GUI 400 can include a viewfinder portion 402 that displays an image of a scene focused onto a light sensor of camera 106 and a user interface element 406 that can be selected on the touchscreen 110 that displays the GUI 400 to capture video content of the scene in the viewfinder. The GUI 400 also can include a user interface element 404 that can be selected to put the mobile computing system into a still photo capture mode, so that still images of the scene displayed in the viewfinder 402 can be captured by the system. The user interface element 406 can be highlighted compared to the user interface element 404, e.g., by a circle around the element 406, by a relative size of the user interface elements, by a distinctive color of the user interface element 406, etc. to indicate that the system 100 is currently in a video capture mode. A prompt associated with the user interface element 406 can indicate to a user that the user interface element 406 can be pressed and held to record video content.

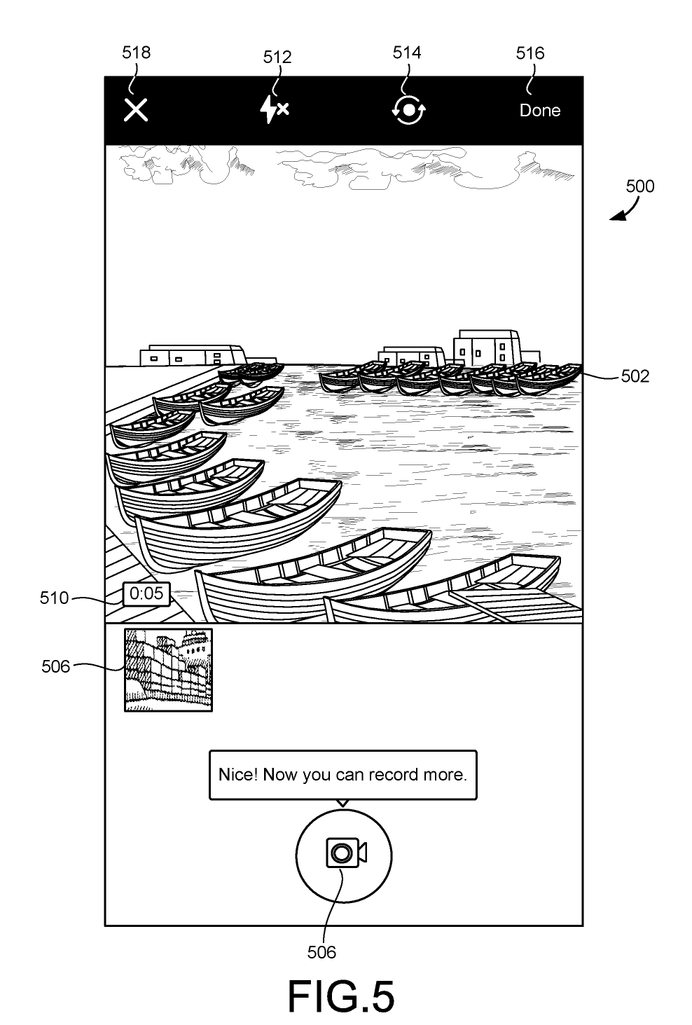

FIG. 5 is a screenshot of a GUI 500 that can be displayed in the touchscreen 110 of the display 108 and that can be used to capture video content and also to display a thumbnail of previously-captured video content. The GUI 500 includes a viewfinder portion 502 that displays an image of a scene focused onto a light sensor of the camera 106 and a user interface element 506 that can be selected on the touchscreen 110 that displays the GUI 500 to capture video content of the scene in the viewfinder 502. Additionally, the GUI 500 includes a user interface element 508 representing video content that was previously captured within the GUI 500. For example, the user interface element 508 can include a thumbnail image of a frame of the previously-captured video content (e.g., a first frame of the previously captured video content or a frame that determined to represent the previously-captured video content well). The user interface element 510 can provide information about a duration of a segment of video content that is currently being captured in the viewfinder 502. For example, as shown in FIG. 5, the user interface element 510 indicates that the five seconds of video content has been captured in the segment displayed in the viewfinder 502.

The GUI 500 can include a user interface element 512 that can be toggled to turn a flash on and off. The GUI 500 can include a user interface element 514 that can be selected to play video content that has been previously captured. For example, a user may tap on the user interface element 508 to select the element and then may select user interface element 514 to play the previously-captured video content represented by the UI element 508. The GUI 500 may include a user interface element 516 that may be selected to indicate that the user has finished capturing video content within the GUI 500 and wishes to return to a different page of the application that provides the GUI 500 to do something with the captured video content (e.g., send a message with the captured video content). In some implementations, the UI element 516 can be selected to display a page of the application in which text characters can be input for a message to one or more other users and to automatically attach or embed the captured video content in a message. The GUI 500 may include the user interface element 518 that can be selected to delete any previously captured video content that is represented in the GUI 500 (e.g., the video content represented by the UI element 508) and to return the user to a different UI.

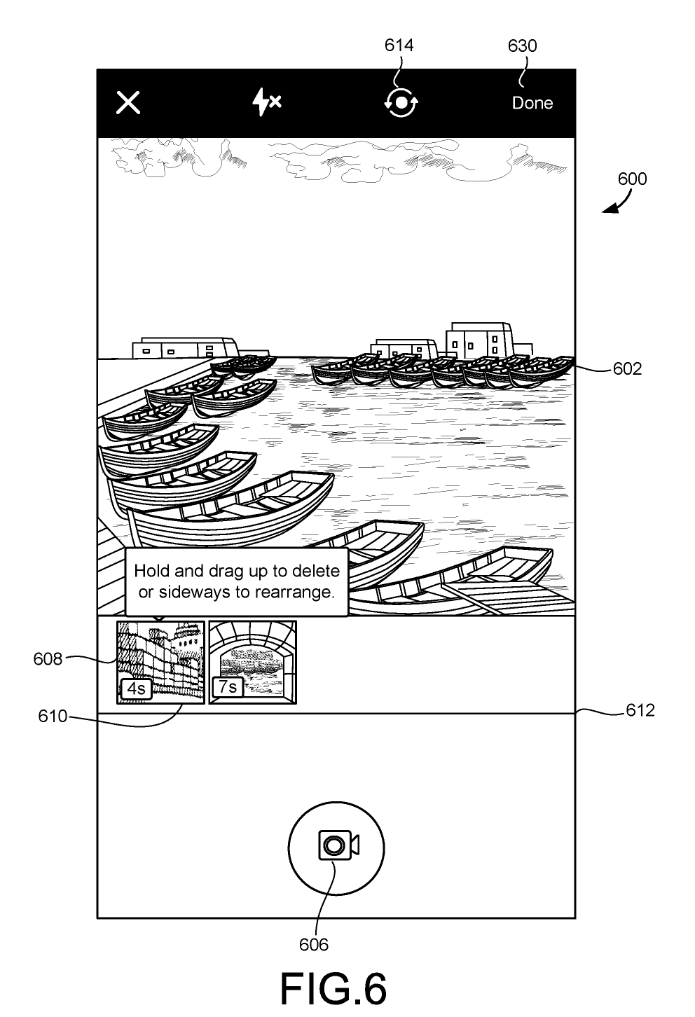

FIG. 6 is a screenshot of a GUI 600 that can be displayed in the touchscreen 110 of the display 108 and that can be used to capture video content and also to display thumbnails of a plurality of previously captured video content segments. The GUI 600 includes a viewfinder portion 602 that displays an image of a scene focused onto a light sensor of the camera 106 and a user interface element 606 that can be selected on the touchscreen 110 that displays the GUI 600 to capture video content of the scene in the viewfinder 602. Additionally, the GUI 600 includes user interface elements 608, 610 representing video content segments that were previously captured within the GUI 600. For example, the user interface elements 608, 610 can include thumbnail images of frames of the previously-captured video content (e.g., a first frame of the previously captured video content segments or frames that are determined to represent the previously-captured video content segments well). The user interface elements 608, 610 can provide information about a duration of the previously-captured video content represented by the elements 608, 610.

The different segments of video content represented by the UI elements 608, 610 can be captured by the user pressing and holding down the user interface element 606 (e.g., by pressing a finger to the UI element 606) for a period of time while pointing the camera at a scene and then releasing the UI element 606 (e.g., by lifting the finger off the UI element 606) to capture a first segment of video content represented by the UI element 608. Then, the user can again press and hold down the user interface element 606 for a second period of time while pointing the camera at a different scene and then releasing the UI element 606 to capture the second segment of video content represented by the UI element 610. The different segments of video content captured within the GUI 606 can be represented by UI elements 608, 610 displayed in a dock 612 used to display a plurality of UI elements representing different segments of captured video content.

The user can review previously-captured video content segments within the GUI 600. For example, a user can select a UI element 608 in the dock 612 (e.g., by tapping on the UI element 608), and then once the UI element is selected, the user can select a playback UI element 614 to play the 608 in the viewfinder portion 602 of the GUI 600.

The different segments of captured video content represented by the UI elements 608, 610 can be combined into a single video file that can be attached to a message sent by the user to one or more other users, e.g., a message that is composed in the same application executing on the system 100 that is used to capture and edit segments of video content and that is broadcasted to other users through a social media platform in which the user and the other user participate. For example, the different segments of captured video content can be played sequentially in the single video file in the order in which they appear in the dock 612. For example, content of the left-most segment 608 in the dock 612 can be played first in the single video file, followed by content of the next segment 610 in the ordered list of segments in the dock 612. The order of the segments in the dock 612 can be re-arranged by a user. For example, a user may select a segment (e.g., by pressing a finger to the UI element representing the segment) and may drag the segment to a different position in the order of segments in the dock 612. Additionally, segments of captured video shown in the dock 612 can be deleted, so they are not included in the single video file that is prepared from the captured video segment(s) in the dock 612. For example, a user may select a segment (e.g., by pressing a finger to the UI element representing the segment) and may drag the segment upward or downward away from the dock 612 to delete the selected segment.

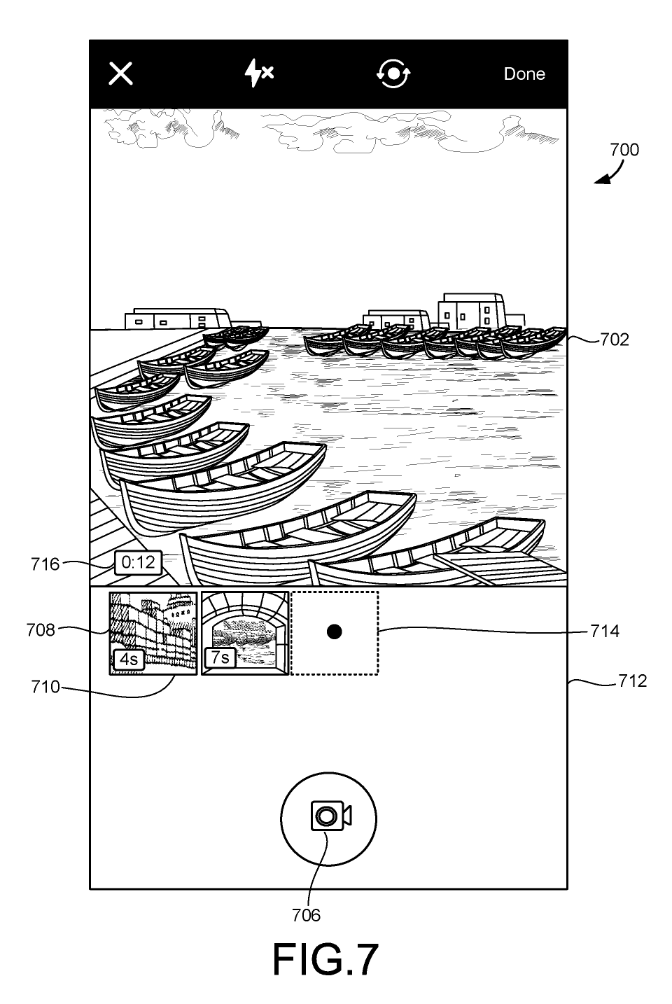

FIG. 7 is a screenshot of a GUI 700 that can be displayed in the touchscreen 110 of the display 108 and that can be used to capture video content and also to display thumbnails of a plurality of previously captured video content segments. The GUI 700 includes a viewfinder portion 702 that displays an image of a scene focused onto a light sensor of the camera 106 and a user interface element 706 that can be selected on the touchscreen 110 that displays the GUI 700 to capture video content of the scene in the viewfinder 702. Additionally, the GUI 700 includes user interface elements 708, 710 representing video content segments that were previously captured within the GUI 700. For example, the user interface elements 708, 710 can include thumbnail images of frames of the previously-captured video content (e.g., a first frame of the previously captured video content segments or frames that are determined to represent the previously-captured video content segments well).

The different segments of video content represented by the UI elements 708, 710 can be captured by the user pressing and holding down the user interface element 706 (e.g., by pressing a finger to the UI element 706) for a period of time while pointing the camera at a scene and then releasing the UI element 706 (e.g., by lifting the finger off the UI element 706) to capture a first segment of video content represented by the UI element 708. Then, the user can again press and hold down the user interface element 706 for a second period of time while pointing the camera at a different scene and then releasing the UI element 706 to capture the second segment of video content represented by the UI element 710. The different segments of video content captured within the GUI 706 can be represented by UI elements 708, 710 displayed in a dock 712 that can display a plurality of UI elements representing different segments of captured video content. While the GUI 700 is used to capture an additional, third, segment of video content, a placeholder UI element 714 can be displayed in the dock 712 to show where the video content currently being captured will be displayed when the capture is complete. Additionally, while video content is being captured in the viewfinder 702, a UI element 716 can display a duration of the video content segment currently being captured in the viewfinder 702, and indications of the length of the previously-captured video content segments can be turned off.

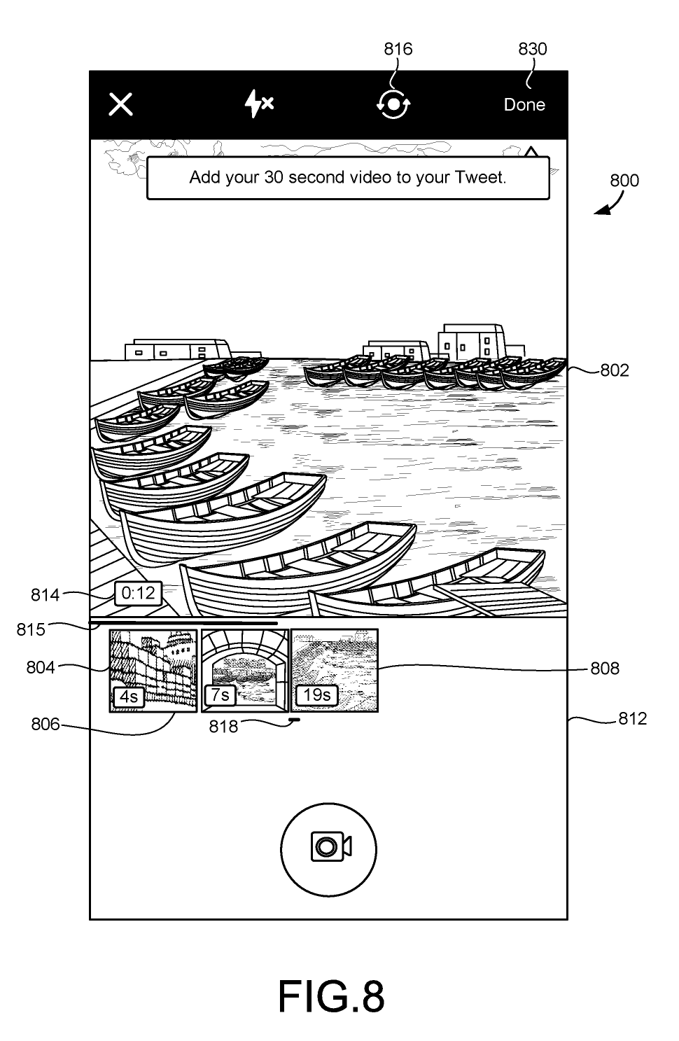

FIG. 8 is a screenshot of a GUI 800 that can be displayed in the touchscreen 110 of the display 108 and that can be used to capture video content, to display thumbnails of a plurality of previously captured video content segments, and to edit previously-captured video segments into a single video file that can be attached to a message that is sent from a user to one or more other users, e.g., a message that is composed in the same application executing on the system 100 that is used to capture and edit segments of video content and that is broadcasted to other users through a social media platform in which the user and the other user participate. The GUI 800 includes a viewfinder portion 802 that can display an image of a scene focused onto a light sensor of the camera 106 and that can playback selected previously-captured video content segments, which are represented by UI elements 804, 806, 808 in a dock 812 of the GUI 800.

As explained above, the video content segments represented by UI elements 804, 806, 808 can be combined into a single video file for attachment to a message to be sent from the mobile computing system 100. A user can edit the order of the different segments within the single video file by using the touchscreen interface to rearrange the order of the UI elements 804, 806, 808 within the dock 812. In some implementations, the duration of the single video file to be attached to the outgoing message can be limited to a predetermined amount of time (e.g., 30 seconds). Thus, in some implementations, the sum of the durations of the plurality of different video content segments displayed in the dock 812 can be limited to the predetermined amount of time. The content editor 114 may limit automatically the duration of the last-captured video content segment, such that the camera automatically stops recording video content when the length of some of the durations of the different video content segments would exceed the predetermined amount of time.

A user also can remove UI elements from the dock 812, thereby deleting the corresponding video content segment from inclusion in the single video content file. For example, the UI element 804, 806, 808 can be removed from the dock 812 by selecting the UI element and then moving it in a vertical direction away from the dock. In this manner, when the duration of the single video file to be attached to the outgoing message is limited to a predetermined amount of time, a user may reclaim time within the single video content file being composed by deleting one or more individual video content segments.

The GUI 800 can include a UI element 814 that represents a time of a frame in the single video file that is composed from the plurality of video content segments, where the frame is displayed in the viewfinder 802. For example, the GUI 800 can include a horizontal progress bar 815 that extends, with increasing length, from the left side of the GUI 800 toward a right side of the GUI as different segments corresponding to UI elements 804, 806, 808 are selected and/or played back in the GUI 800. For example, in GUI 800, a total of 30 seconds of video content in three different video content segments is represented by the different UI elements 804, 806, 808 displayed in the dock 812. When UI element 804, which corresponds to four seconds of video content, is selected, and 30 seconds is the maximum duration of the single video content file or when a total of 30 seconds of video content is represented by the UI elements 804, 806, 808 displayed in the dock 812, the UI element 804 can extend 4/30ths of the horizontal distance across the GUI 800, or across the horizontal width of the viewfinder 802, or across some other predetermined maximum extent of the UI element 814. The predetermined maximum extent of the UI element 814 can correspond to the predetermined maximum duration of video content that can be included in the single video content file or, in another implementation can correspond to the total duration of video content represented by the UI elements 804, 806, 808 displayed in the dock 812. If the user selects the UI element 816 to playback the video content segment corresponding to the selected UI element 804, the progress bar may progress from 0% to 13.3% (i.e., 4/30^{th}) of the way across its maximum extent as the video content of the segment is played back. When the video content corresponding to the UI element 808 is selected and played back, the progress bar may progress from 36.7% (i.e., 11/30^{th}) to 100% of the way across its maximum extent as the video content of the segment is played back. As shown in FIG. 8, the UI element indicates that second 12 of the 30 seconds of video content is being played, so the horizontal progress bar 815 can extend 40% ( 12/30^{th}) of the way across the width of the UI.

In some implementations, the GUI 800 can include one or more UI elements that can include second horizontal progress bar(s) 818 that each correspond to a screenshot 804, 806, 808 of a captured video segment. The horizontal progress bars 818 that correspond to a screenshot of a particular captured video segment can be illuminated and/or can have a length that increases from left to right as the video content of the particular captured segment is played back. As shown in FIG. 8, the UI element indicates that second 12 of the 30 seconds of video content is being played, corresponding to the first second of the third segment of video content so the second horizontal progress bar 818 can 1/19^{th} of the way across the width of the screenshot 808.

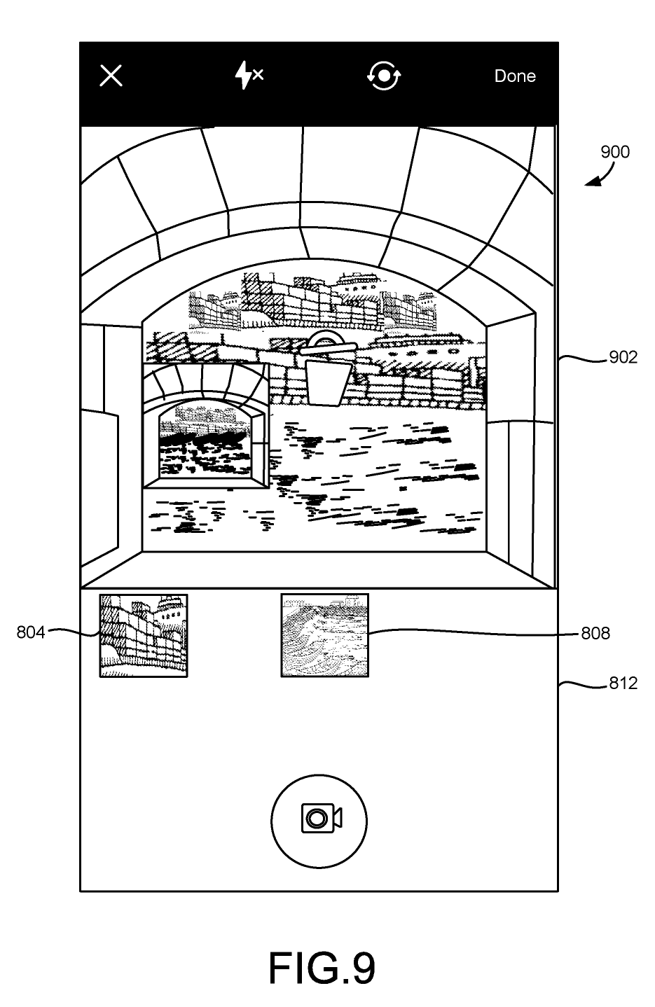

FIG. 9 is a screenshot of a GUI 900 that can be displayed in the touchscreen 110 of the display 108 and that can be used to display thumbnails of a plurality of previously captured video content segments and to edit previously-captured video segments into a single video file that can be attached to a message that is sent from a user to one or more other users, e.g., a message that is composed in the same application executing on the system 100 that is used to capture and edit segments of video content and that is broadcasted to other users through a social media platform in which the user and the other user participate. The GUI 900 illustrates the process of deleting the segment corresponding to UI element 806 from the plurality of segments that are displayed in dock 812 in FIG. 8. The UI element 806 has been selected and dragged upward from the dock to delete the segment.

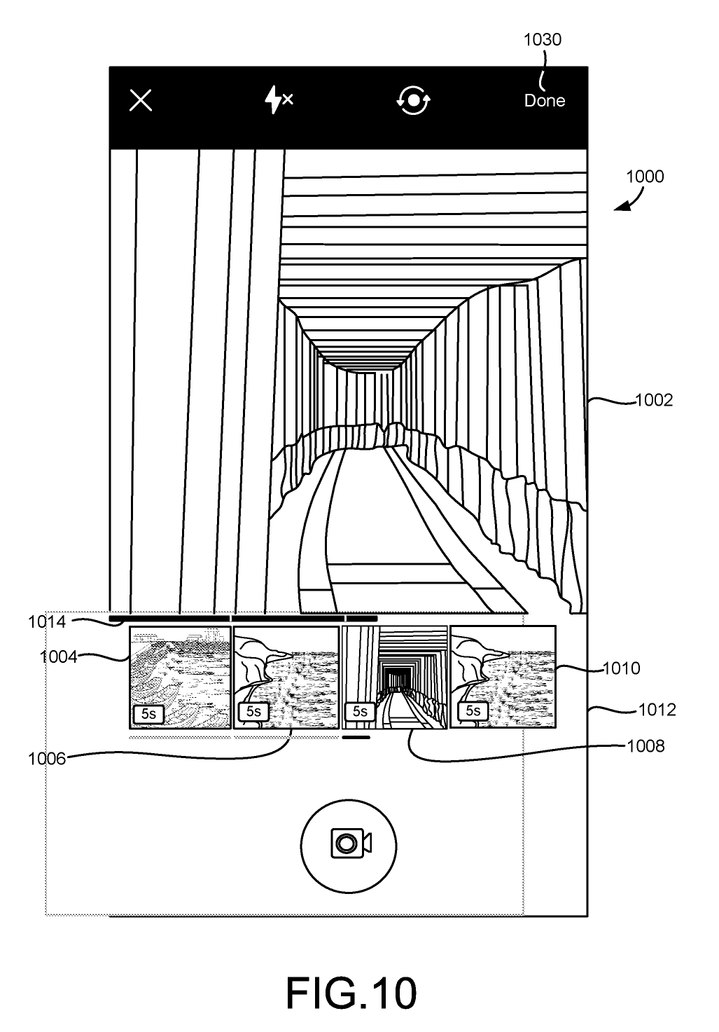

FIG. 10 is a screenshot of a GUI 1000 that can be displayed in the touchscreen 110 of the display 108. The GUI 1000 includes UI elements 1004, 1006, 1008, 1010 that correspond to video content segments that were previously captured in the GUI 1000 and that now are displayed in a dock 1012 of the GUI 1000. A UI element 1014 can represent a time of a frame in the single video file that is composed from the plurality of video content segments, where the frame is displayed in the viewfinder 1002. For example, the UI element 1014 can include a horizontal progress bar that moves from the left side of the GUI 1000 to a right side of the GUI as different segments corresponding to UI elements 1004, 1006, 1008, 1010 are selected and/or played back in the GUI 1000. For example, in GUI 1000, a total of 20 seconds of video content in four different video content segments is represented by the different UI elements 1004, 1006, 1008, 1010 displayed in the dock 1012. When UI element 1008, which corresponds to five seconds of video content, is being played in the viewfinder 1002, the UI element 1014 can grow from 50% to 75% of its maximum extent across the GUI 1000 as playback of the video content segment progresses. The UI element 1014 can include small vertical breaks in the horizontal progress bar to indicate the end of one video content segment and the beginning of a following video content segment. In another implementation, the GUI 1000 can include one or more UI elements 1018 that can include second horizontal progress bar(s) that each correspond to a screenshot 1004, 1006, 1008, 1010 of a captured video segment. The horizontal progress bars that correspond to a screenshot of a particular captured video segment can be illuminated and/or can have a length that increases from left to right as the video content of the particular captured segment is played back, but that are blacked or grayed out or that have a static length when their corresponding video content is not being played back.

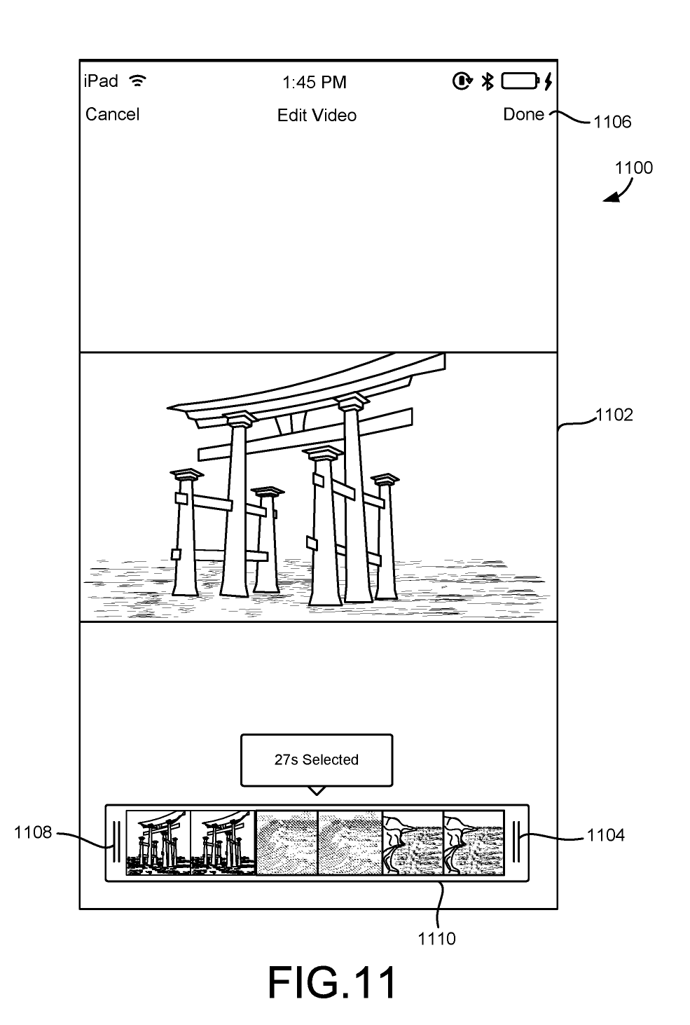

FIG. 11 is a screenshot of the GUI 1100 that can be displayed in the touchscreen 110 of the display 108 and can be used for editing and playing back video content. In some implementations, GUI 1100 can be displayed as a consequence of a user selecting a user interface element 630 (in FIG. 6), 830 (in FIG. 8), 1030 (in FIG. 10) to indicate that the user has finished composing a single video content file from the plurality of previously-captured video content segments. In some implementations, GUI 1100 can be displayed as a consequence of a user selecting an individual video content segment for editing. For example, in some implementations, a user may select an individual video content segment for editing by long-tapping on a UI element 608, 610, 708, 710, 804, 806, 808, 1004, 1006, 1008 1010 (i.e. pressing on the UI element for longer than a predetermined amount of time).

Once the single video content file or the individual video content segment has been selected for editing, the GUI 1100 can display a UI element 1104 that includes a plurality of frames of the selected content. The plurality of frames in the UI element 1104 can be displayed in an order in which the frames are played when the content is rendered. A user may interact with the UI element 1104 to trim the length of the selected content, for example by selecting a start and end frame and then selecting a UI element 1106 to indicate that the user is finished with the editing process. In some implementations, the UI element 1104 may display a predetermined number of frames of the selected video content. The user may scroll backward and forward in the frames of the content, for example, by interacting with edges 1108, 1110 of the UI element 1104, and the user may select start and end frames with which to trim the length of the video content by tapping the start and end frames in the touchscreen 110 that displays the GUI 1100 when they are displayed in the UI element 1104.

Once the user has selected the start and end frame of the trimmed video content of the single video content file or the individual video content segment, a user can select a user interface element 1106 to indicate that the trimming process is complete. In the case of trimming an individual video content segment selection of the user interface element 1106 can return the user to a GUI similar to GUI 600, GUI 804 GUI 1000, in which a plurality of video content segments, including the trimmed video content segment, are displayed. In the case of trimming a single video content file composed of a plurality of different video content segments, selection of the user interface element 1106 can call up a new GUI with which the user can add additional information to the message that will be sent with the single video content file attached.

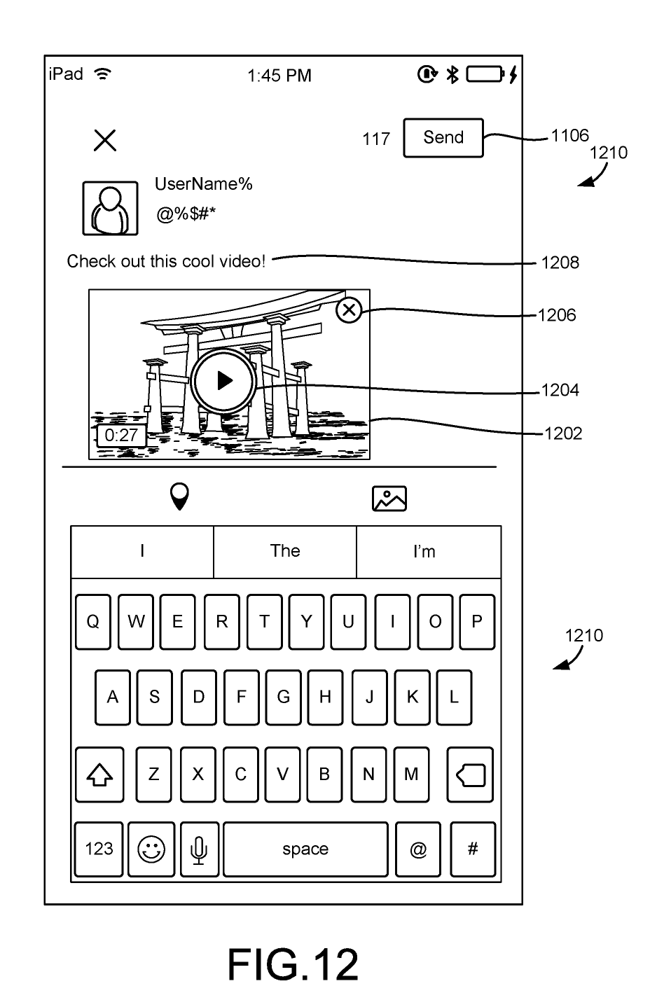

FIG. 12 is a screenshot of a GUI 1200 that can be used to generate a message to accompany the single video file composed from content of the plurality of different video content segments. The GUI 1200 can display a UI element 1202 representing the single video file. The UI element 1202 can include a first UI sub-element 1204 can be selected to play the single video content file in the UI 1200 and a second UI sub-element 1206 that can be selected to delete the single video file from the message that is being generated. The GUI 1200 can include a text field 1208 in which a text-based message can be generated to accompany the single video content file. A virtual keyboard 1210 can be displayed in the GUI 1200 and can be used to type a message for display in the text field 1208. When a user is satisfied with the text in the text field 1208 and with the single video content file represented by UI element 1202, the user can send the message that includes the text in the text field and the single video content file. The message can be sent to one or more other users, for example, through an email protocol, through a SMS message protocol, through a post to a social media website, etc.

The message that is sent by the user can be a message that is broadcasted to other users through a social media platform in which the user and the other user participate. The other user can be users that are linked to, that are friends with, or that follow, the user through the social media platform. When the message is received by the other users it can be inserted into chronological timelines of messages received by the other users within a user interface of the social media application, where receipt of a message by another user is based on a follower-subscription model, in which only other users who subscribe to the messages sent out by the user receive the sent message for insertion into their timelines.

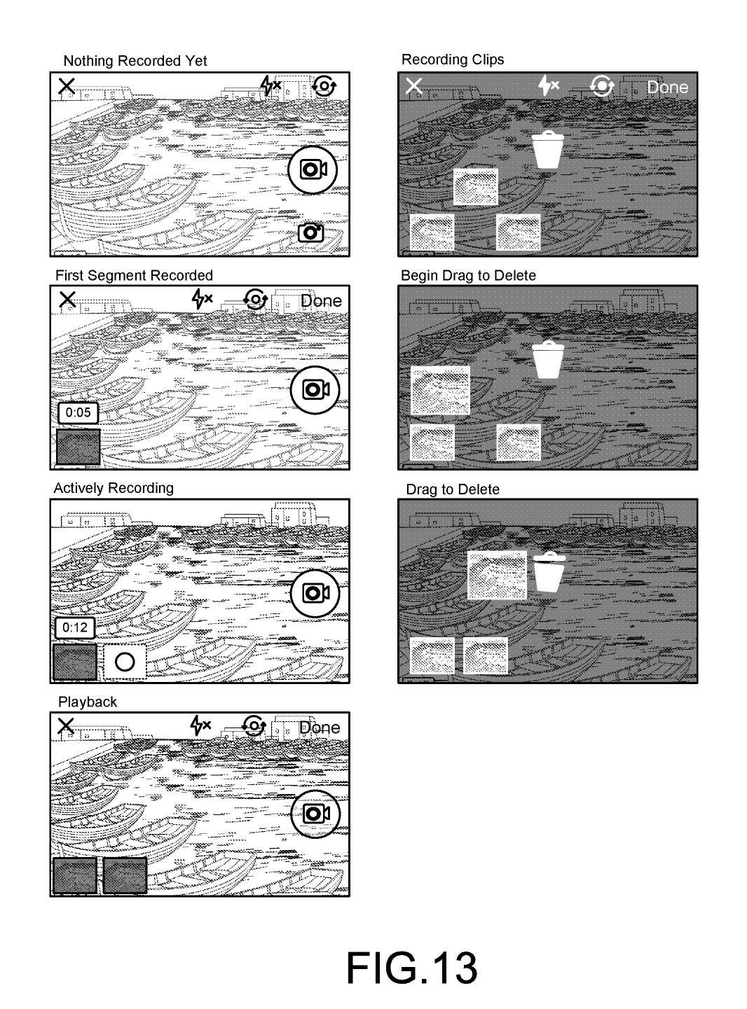

FIG. 13 shows seven different screenshots of different GUIs showing how the techniques described herein can also be implemented in landscape orientations of the GUIs. In the landscape orientations of the GUIs, video content, and still frames of the video content, may be displayed in a larger portion of the display 108 then when portrait orientations of the GUIs are used. Additional user interface elements that are used, for example, to start and stop the capture of video to content, that represent previously-captured video content segments, with which a user can replay selected video, that can be used to reorder individual video content segments or to delete individual video content segments, that can be toggled to turn on/off a flash, etc., can be displayed over video or still frame content that is displayed in the landscape orientation.

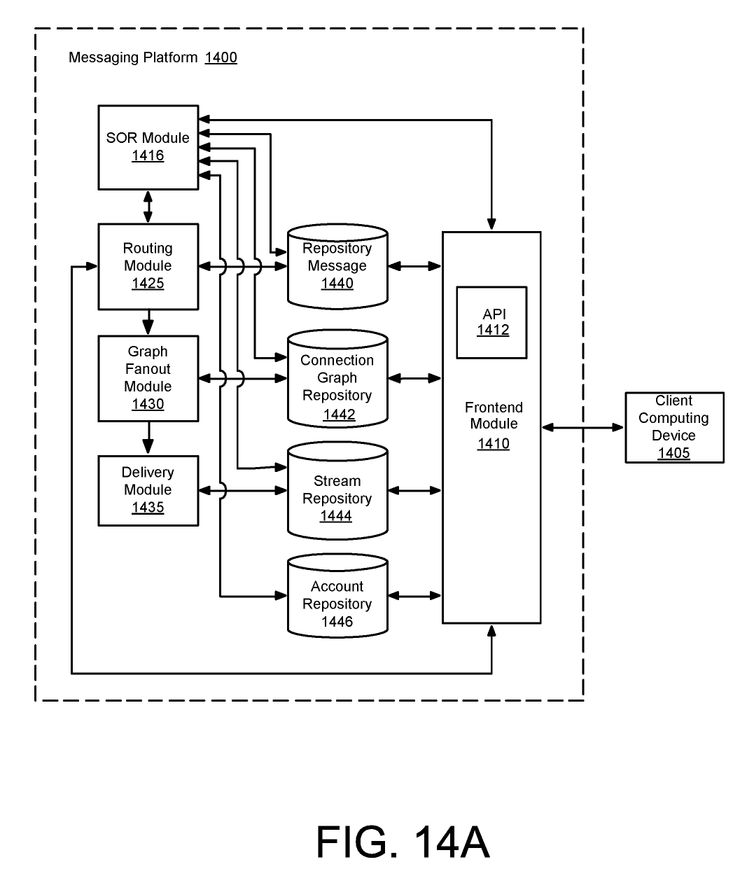

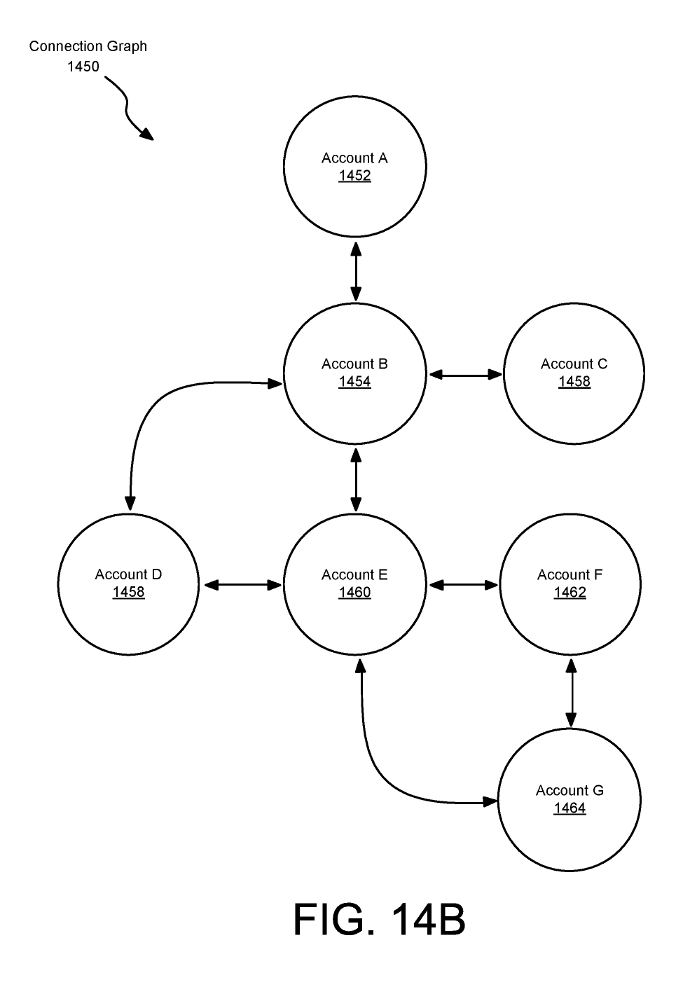

FIG. 14A shows a messaging platform 1400 and a client computing device 1405 that can be used to compose and send a message containing a single video content file composed of a plurality of video content segments captured with the a mobile computing device. As shown in FIG. 14A, the messaging platform 1400 has multiple components including a frontend module 1410 with an application programming interface (API) 1412, a strength of relationship (SOR) module 1416, a routing module 1425, a graph fanout module 1430, a delivery module 1435, a message repository 1440, a connection graph repository 1442, a stream repository 1444, and an account repository 1446. One or more components of the messaging platform 1400 can be communicatively coupled with one or more other components of the messaging platform 1400 (e.g., the SOR module 1416 may be communicatively coupled with the frontend module 1410 and the routing module 1425). Various components of the messaging platform 1400 can be located on the same device (e.g., a server, mainframe, desktop Personal Computer (PC), laptop, Personal Digital Assistant (PDA), telephone, mobile phone, kiosk, cable box, and any other device) or can be located on separate devices connected by a network (e.g., a local area network (LAN), the Internet, etc.). Those skilled in the art will appreciate that there can be more than one of each separate component running on a device, as well as any combination of these components within a given implementation of the invention.

In one or more implementations, the messaging platform 1400 is a platform for facilitating real-time communication between one or more entities. For example, the messaging platform 1400 may store millions of accounts of individuals, businesses, and/or other entities (e.g., pseudonym accounts, novelty accounts, etc.). One or more users of each account may use the messaging platform 1400 to send messages to other accounts inside and/or outside of the messaging platform 1400. The messaging platform 1400 may be configured to enable users to communicate in “real-time”, i.e., to converse with other users with a minimal delay and to conduct a conversation with one or more other users during concurrent sessions. In other words, the messaging platform 1400 may allow a user to broadcast messages and may display the messages to one or more other users within a reasonable time frame so as to facilitate a live conversation between the users. Recipients of a message may have a predefined graph relationship with an account of the user broadcasting the message (e.g., based on an asymmetric graph representing accounts as nodes and edges between accounts as relationships). In one or more implementations, the user is not an account holder or is not logged in to an account of the messaging platform 1400. In this case, the messaging platform 1400 may be configured to allow the user to broadcast messages and/or to utilize other functionality of the messaging platform 1400 by associating the user with a temporary account or identifier.

In one or more implementations, the SOR module 1416 includes functionality to generate one or more content groups, each including content associated with a subset of unviewed messages of an account of the messaging platform 1400. Relationships between accounts of the messaging platform 1400 can be represented by a connection graph.

FIG. 14B shows an example depiction of a connection graph 1450 in accordance with one or more implementations of the invention. In one or more implementations, the connection graph repository 1442 is configured to store one or more connection graphs. As shown in FIG. 14B, the connection graph 1450 includes multiple components including nodes representing accounts of the messaging platform 1400 (i.e., Account A 1452, Account B 1454, Account C 1456, Account D 1458, Account E 1460, Account F 1462, Account G 1464) and edges connecting the various nodes.

The connection graph 1450 is a data structure representing relationships (i.e., connections) between one or more accounts. The connection graph 1450 represents accounts as nodes and relationships as edges connecting one or more nodes. A relationship may refer to any association between the accounts (e.g., following, friending, subscribing, tracking, liking, tagging, and/or etc.). The edges of the connection graph 1450 may be directed and/or undirected based on the type of relationship (e.g., bidirectional, unidirectional), in accordance with various implementations of the invention.

Many messaging platforms include functionality to broadcast streams of messages to one or more accounts based at least partially on a connection graph representing relationships between those accounts (see FIG. 14B). A stream may be a grouping of messages associated with one or more accounts or can reflect any arbitrary organization of messages that is advantageous for the user of an account. In accordance with various implementations of the invention, a “message” is a container for content broadcasted/posted by or engaged by an account of a messaging platform. Messages can be authored by users and can include any number of content types (multimedia, text, photos, and video content, including a single video content file that includes a plurality of different video content segments, etc.).

Returning to FIG. 14A, in one or more implementations, the SOR module 1416 includes functionality to receive, in association with a request to establish a graph relationship between a recipient account and a connected account, a strength of relationship from the recipient account to the connected account. The recipient account may be any account of the messaging platform 1400 and the connected account may be any account of the messaging platform 1400 to which the recipient account has formed a graph connection (e.g., follower, friendship, interest, etc.). The recipient account may receive a stream including messages broadcasted by one or more accounts including the connected account. For example, the recipient account may form a relationship with the connected account using a request to connect with the connected account (e.g., “follow” the connected account to receive messages broadcasted by the connected account), and as a result, a connection graph relationship may be established between the recipient account and connected account. Messages broadcasted by the connected account may then be included in a stream of the recipient account.

The strength of relationship from the recipient account to the connected account is not limited to any particular form. A strength of relationship can be a numerical value, e.g., a value in the range 0 through 10 with 0 representing a weakest relationship and 10 a strongest relationship. The numerical values may be continuous in a range or limited to discrete values in a range, e.g., integer values within the range 0 through 10 and/or percentage values within a range of 0 through 100 percent. An indication of a strength of relationship can be a text indicator. A text indicator can specify strength levels, e.g., “Lowest”, “Low”, “Medium”, “High”, “Highest”. A text indicator can be descriptive, e.g., “Casual”, “Highly Interested”, “Friend”, “Fan”, “Acquainted”. A text indicator can describe a relationship category, e.g., “Friend”, “Family”, “News”, “Professional”. Each indication can correspond with a predefined numeric (or other) strength of relationship value.

A strength of relationship can reflect the subjective or objective interests or preferences of the user of the recipient account. For example, a user of the recipient account may have a mild interest in the connected account and initially select a moderately strong relationship. Then after consuming content from the connected account, the recipient account may upgrade the relationship to a stronger relationship or downgrade it to a weaker one. A user possessing a particularly strong interest in the connected account (e.g., a celebrity or unique news or information source) can choose a relationship of the highest strength (e.g., “Highly Interested” or 10 on a scale of 10).

A relative strength or weakness of a relationship can be interpreted depending on a particular user content presentation. For example, it may be determined that weak relationships are more correlated with interest, while strong relationships are more correlated with social connections. Thus, an interest-based timeline (e.g., a discover timeline) can weight weak relationships more heavily, while a social-based timeline can weight strong relationships more heavily.

In addition, a strength of relationship can be used to establish a negative correlation. For example, if a user is blocking a particular account, then the messaging platform 1400 can also block messages from accounts with strong relationships to the particular account and messages from accounts to which the particular account has a strong relationship.

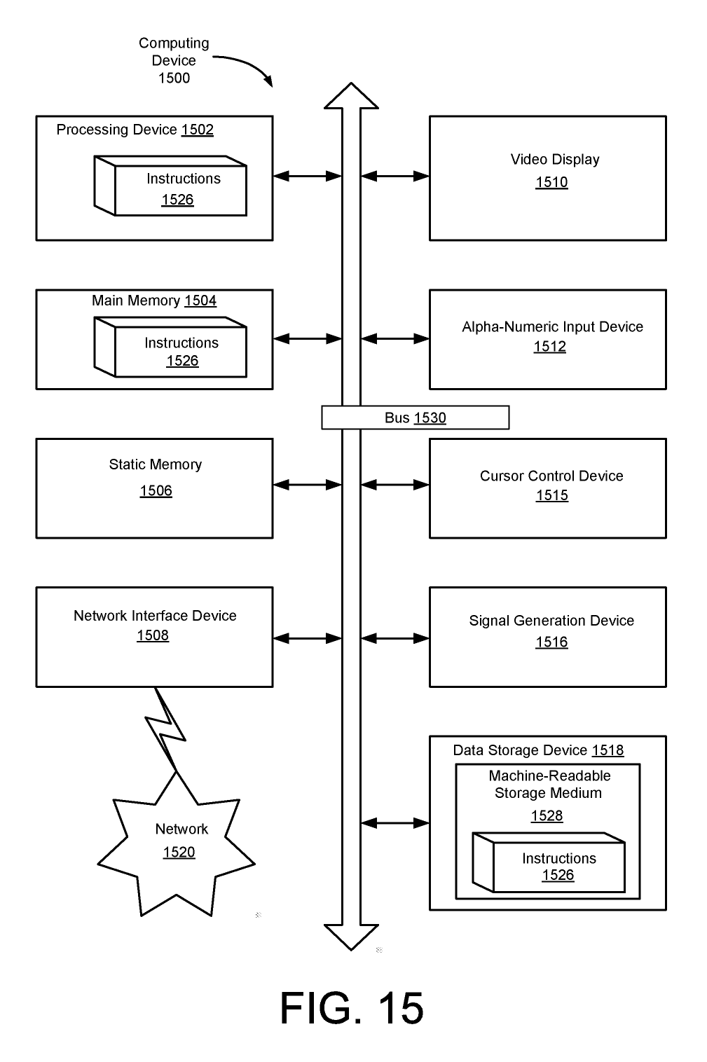

FIG. 15 illustrates a diagrammatic representation of a machine in the example form of a computing device 1500 within which a set of instructions, for causing the machine to perform any one or more of the methodologies discussed herein, may be executed. The computing device 1500 may include a mobile phone, a smart phone, a netbook computer, a personal computer, a laptop computer, a tablet computer, a desktop computer, a camera, etc., within which a set of instructions, for causing the machine to perform any one or more of the methodologies discussed herein, may be executed. In one implementation, the computing device 1500 may present GUIs to a user with which the user can capture individual video content segments, playback the segments, edit the segments, and combine the segments into a single video content file (as discussed above). The machine may be connected (e.g., networked) to other machines in a LAN, an intranet, an extranet, or the Internet. The machine may operate in the capacity of a client machine in client-server network environment. Further, while only a single machine is illustrated, the term “machine” shall also be taken to include any collection of machines that individually or jointly execute a set (or multiple sets) of instructions to perform any one or more of the methodologies discussed herein.

The example computing device 1500 includes a processing device (e.g., a processor) 1502, a main memory 1504 (e.g., read-only memory (ROM), flash memory, dynamic random access memory (DRAM) such as synchronous DRAM (SDRAM)), a static memory 1506 (e.g., flash memory, static random access memory (SRAM)) and a data storage device 1518, which communicate with each other via a bus 1530.

Processing device 1502 represents one or more general-purpose processing devices such as a microprocessor, central processing unit, or the like. More particularly, the processing device 1502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1502 may also be one or more special-purpose processing devices such as an application specific integrated circuit (ASIC), a field programmable gate array (FPGA), a digital signal processor (DSP), network processor, or the like. The processing device 1502 is configured to execute instructions 1526 (e.g., instructions for an application ranking system) for performing the operations and steps discussed herein.

The computing device 1500 may further include a network interface device 1508 which may communicate with a network 1520. The computing device 1500 also may include a video display unit 1510 (e.g., a liquid crystal display (LCD), a light-emitting diode (LED), or organic light emitting diode (OLED) display), an alphanumeric input device 1512 (e.g., a keyboard), a cursor control device 1514 (e.g., a trackball, a trackpad, or a mouse) and a sound generation device 1516 (e.g., a speaker). In one implementation, the video display unit 1510, the alphanumeric input device 1512, and the cursor control device 1514 may be combined into a single component or device (e.g., an LCD touch screen).

The data storage device 1518 may include a computer-readable storage medium 1528 on which is stored one or more sets of instructions 1526 (e.g., instructions for the application ranking system) embodying any one or more of the methodologies or functions described herein. The instructions 1526 may also reside, completely or at least partially, within the main memory 1504 and/or within the processing device 1502 during execution thereof by the computing device 1500, the main memory 1504 and the processing device 1502 also constituting computer-readable media. The instructions may further be transmitted or received over a network 1520 via the network interface device 1508.

While the computer-readable storage medium 1428 is shown in an example implementation to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media and magnetic media.

In the above description, numerous details are set forth. It will be apparent, however, to one of ordinary skill in the art having the benefit of this disclosure, that implementations of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying,” “determining,” “calculating,” “updating,” “transmitting,” “receiving,” “generating,” “changing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

The above description sets forth numerous specific details such as examples of specific systems, components, methods and so forth, in order to provide a good understanding of several implementations of the present disclosure. It will be apparent to one skilled in the art, however, that at least some implementations of the present disclosure may be practiced without these specific details. In other instances, well-known components or methods are not described in detail or are presented in simple block diagram format in order to avoid unnecessarily obscuring the present disclosure. Thus, the specific details set forth above are merely examples. Particular implementations may vary from these example details and still be contemplated to be within the scope of the present disclosure.

It is to be understood that the above description is intended to be illustrative and not restrictive. Many other implementations will be apparent to those of skill in the art upon reading and understanding the above description. The scope of the disclosure should, therefore, be determined with reference to the aspects enumerated below, along with the full scope of equivalents to which such aspects are entitled.

What is claimed is:

1. A method, comprising:
capturing a first segment of video content;
displaying the video content of the captured first segment in a first page of a graphical user interface (GUI) of an application executing on a mobile device as the first segment is being captured, wherein the GUI is displayed on a touchscreen;
capturing a second segment of video content, wherein the second segment is not temporally contiguous with the first segment; and
as the second segment is being captured, displaying a first static screenshot of a frame of the first segment of video content in the page of the GUI and displaying the video content of the captured second segment in the page of the GUI.

2. The method of claim 1, further comprising, after the second segment is captured, displaying, in the first page of the GUI, the first static screenshot and a second static screenshot of a frame of the second segment of video content.

3. The method of claim 2, further comprising generating a single file of video content that includes the first and second segments.

4. The method of claim 3, further comprising:
displaying, in the first page of the GUI, the first and second static screenshots within the page in a predetermined order;
receiving a user's interaction, on the touchscreen, with at least one of the static screenshots; and
in response to the received user's interaction, displaying the first and second static screenshots within the first page in a user-determined order different from the predetermined order,
wherein the single file of video content includes the content of the first and second segments arranged in the user-determined order.

5. The method of claim 4 wherein the predetermined order is the order in which the segments were captured.

6. The method of claim 4, further comprising ordering the first and second segments of video content for playback in the single file of video content in the user-determined order.

7. The method of claim 4, further comprising:
receiving a user's selection, on the touchscreen, of one of the first or second static screenshots; and
in response to receiving the user selection, playing back the video content corresponding to the selected static screenshot in the page while displaying the non-selected static screenshot in the page.

8. The method of claim 3, further comprising:
after generating the single file of video content that includes the first and second segments, receiving a first user input to the GUI in the first page;
in response to receiving the first user input to the GUI:
displaying, in a second page of the GUI of the application, a text entry GUI for receiving text input by the user for inclusion in a message to be sent to other users, and
attaching the single file of video content to the message to be sent to other users.

9. The method of claim 8, wherein the first user input to the GUI includes a single touch of the touchscreen.

10. The method of claim 8, further comprising sending the message to be broadcasted to other users through a social media platform in which the user and the other user participate.

11. The method of claim 8, further comprising:
displaying in the second page of the GUI of the application a user interface element that is selectable to initiate the capture of the segments of video content.

12. The method of claim 3, further comprising:
capturing three or more segments of video content, wherein the segments are not temporally contiguous with each other;
displaying static screenshots corresponding to the three or more segments of video content within the first page in a predetermined order;
receiving a user's selection, on the touchscreen, with at least one of the static screenshots;
in response to the received user's selection, deleting the selected static screenshot from the display;
receiving a user's interaction, on the touchscreen, with at least one of the displayed static screenshots; and
in response to the received user's interaction, displaying the static screenshots that have not been deleted within the page in a user-determined order different from the predetermined order,
wherein the single file of video content includes the content of the segments of video content corresponding to the displayed static screenshots, after the selected static screenshot has been deleted, arranged in the user-determined order.

13. A mobile computing system comprising:
a camera configured for capturing segments of video content that are not temporally contiguous;
a display including a touchscreen configured for displaying the captured segments of the video content and for displaying static screenshots of the captured segments of the video content and for receiving user interactions with the touchscreen;
one or more memory devices configured for storing executable instructions; and
one or more processors configured for executing the instructions,
wherein execution of the instructions causes the system to:
capture a first segment of video content;
display the video content of the captured first segment in a first page of a graphical user interface (GUI) of an application executing on the mobile computing system as the first segment is being captured, wherein the GUI is displayed on the touchscreen;
capture a second segment of video content, wherein the second segment is not temporally contiguous with the first segment; and
as the second segment is being captured, display a first static screenshot of a frame of the first segment of video content in the page of the GUI and display the video content of the captured second segment in the page of the GUI.

14. The mobile computing system of claim 13,
wherein the display, the one or more memory devices, and the one or more processors are integrated into a first single housing,
wherein the camera is located a second housing peripheral to the first housing, and
wherein the camera communicates with the one or more processors over a wireless link.

15. The mobile computing system of claim 13, wherein execution of the instructions further causes the system to: after the second segment is captured, display, in the first page of the GUI, the first static screenshot and a second static screenshot of a frame of the second segment of video content.

16. The mobile computing system of claim 15, wherein execution of the instructions further causes the system to: generate a single file of video content that includes the first and second segments.

17. The mobile computing system of claim 16, wherein execution of the instructions further causes the system to:
display, in the first page of the GUI, the first and second static screenshots within the page in a predetermined order;
receive a user's interaction, on the touchscreen, with at least one of the static screenshots; and
in response to the received user's interaction, display the first and second static screenshots within the first page in a user-determined order different from the predetermined order,
wherein the single file of video content includes the content of the first and second segments arranged in the user-determined order.

18. The mobile computing system of claim 17, wherein the predetermined order is the order in which the segments were captured.

19. The mobile computing system of claim 17, wherein execution of the instructions further causes the system to order the first and second segments of video content for playback in the single file of video content in the user-determined order.

20. The mobile computing system of claim 17, wherein execution of the instructions further causes the system to:
receive a user's selection, on the touchscreen, of one of the first or second static screenshots; and
in response to receiving the user selection, play back the video content corresponding to the selected static screenshot in the page while displaying the non-selected static screenshot in the page.

21. The mobile computing system of claim 16, wherein execution of the instructions further causes the system to:
after generating the single file of video content that includes the first and second segments, receive a first user input to the GUI in the first page; and
in response to receiving the first user input to the GUI:
display, in a second page of the GUI of the application, a text entry GUI for receiving text input by the user for inclusion in a message to be sent to other users, and
attach the single file of video content to the message to be sent to other users.

22. The mobile computing system of claim 21, wherein the first user input to the GUI includes a single touch of the touchscreen.

23. The mobile computing system of claim 16, wherein execution of the instructions further causes the system to:
capture three or more segments of video content, wherein the segments are not temporally contiguous with each other;
display static screenshots corresponding to the three or more segments of video content within the first page in a predetermined order;
receive a user's selection, on the touchscreen, with at least one of the static screenshots;
in response to the received user's selection, delete the selected static screenshot from the display;
receive a user's interaction, on the touchscreen, with at least one of the displayed static screenshots; and
in response to the received user's interaction, display the static screenshots that have not been deleted within the page in a user-determined order different from the predetermined order, wherein the single file of video content includes the content of the segments of video content corresponding to the displayed static screenshots, after the selected static screenshot has been deleted, arranged in the user-determined order.

24. A mobile computing system comprising:
a camera configured for capturing segments of video content that are not temporally contiguous;
a display including a touchscreen configured for displaying the captured segments of the video content and for displaying static screenshots of the captured segments of the video content and for receiving interactions by a user with the touchscreen;
one or more memory devices configured for storing executable instructions; and
one or more processors configured for executing the instructions,
wherein execution of the instructions causes the system to execute an application on the mobile computing device for receiving and displaying a stream of messages that have been broadcast by other users, wherein execution of the application includes:
capturing a plurality of segments of video content that are not temporally contiguous in a page of a graphical user interface (GUI) of the application;
displaying the video content of the captured segments in the page of the GUI on the touchscreen as the segments are being captured, while displaying static screenshots of frames other one or more captured segments in the page;
in response to receiving a user's interaction with one or more of the static screenshots through the touchscreen, generating a single file of video content that includes the video content of two or more of the segments;
receiving, through the GUI of the application, text input by the user for inclusion in a message to be broadcast to other users; and
attaching the single file of video content to the message to be broadcast.
